(19) United States
(12) Patent Application Publication
(10) Pub. No.: US 2022/0072916 A1
(43) Pub. Date: Mar. 10, 2022

(54) VARIABLE RISER DEVICE

(71) Applicant: CHAD OSHLEY, PROVO, UT (US)

(72) Inventor: CHAD OSHLEY, PROVO, UT (US)

(21) Appl. No.: 17/468,576

(22) Filed: Sep. 7, 2021

Related U.S. Application Data
(60) Provisional application No. 63/074,615, filed on Sep. 4, 2020.

(51) Int. Cl. B60C 25/01

(52) U.S. Cl. CPC B60C 25/015; B25B 27/00

(57) ABSTRACT

A variable riser device includes an elongate member having a plurality of steps along a length of the elongate member. Each step is located on a different side of the elongate member. Also, each step includes a top flat surface that juts perpendicularly inward toward the linear straight axis of the elongate member. Each step is spaced linearly apart from each other along the length of the elongate member.

### BACKGROUND

A rim of a tire may be removed by prying the edge of the rim away from the bead of the tire. This may be accomplished, for example, by incrementally lifting or pulling the edge of the rim in increments around the tire.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 illustrates a perspective view of variable riser device according to an example of the principles described herein.

FIG. 2 illustrates a perspective view of a variable riser device according to an example of the principles described herein.

FIG. 3 illustrates a perspective view of a variable riser device according to an example of the principles described herein.

FIG. 4 illustrates a perspective view of a variable riser device according to an example of the principles described herein.

FIG. 5 illustrates a perspective view of a variable riser device according to an example of the principles described herein.

FIG. 6 illustrates a perspective view of a variable riser device according to an example of the principles described herein.

FIG. 7 illustrates a perspective view of a variable riser device according to an example of the principles described herein.

FIG. 8 illustrates a perspective view of a variable riser device according to an example of the principles described herein.

FIG. 9 illustrates a top view of a variable riser device according to an example of the principles described herein.

FIG. 10a illustrates a perspective view of a variable riser device being used according to an example of the principles described herein.

FIG. 10b illustrates a perspective view of a variable riser device being used according to an example of the principles described herein.

FIG. 11a illustrates a variable riser device being used to remove tire flange according to an example of the principles described herein.

FIG. 11b illustrates a variable riser device being used to remove tire flange according to an example of the principles described herein.

FIG. 11c illustrates a variable riser device being used to remove tire flange according to an example of the principles described herein.

FIG. 11d illustrates a variable riser device being used to remove tire flange according to an example of the principles described herein.

FIG. 12a illustrates an exploded view of a five multipiece rim according to an example of the principles described herein.

FIG. 12b illustrates a five multipiece rim according to an example of the principles described herein.

FIG. 13 illustrates a perspective view of a variable riser device and a handle according to an example of the principles described herein.

### DETAILED DESCRIPTION

Tire changes, particularly for large tires, can require a great amount of force and maneuvering. A multi-piece wheel assembly is used on an industrial tire. The following describes a variable riser device that is used to break a seal and maintain a separation of a tire and rim of a multi-piece wheel assembly.

A tire and rim may be separated from a multi-piece wheel assembly with a bead breaker. Breaker teeth and a foot of the bead breaker are aligned against the rim and tire bead of a wheel assembly. The bead breaker is damped on to the face of the wheel to pull the teeth and foot between the fire and rim bead, with hydraulic pressure provided by a pump. Once the bead breaker is aligned with the fire bead, the foot will extend hydraulically and push the tire bead away from the rim bead. The bead breaker teeth and claw may extend, for example, 1 to 2 inches. The extended length allows the bead breaker to align itself properly when it pulls in between the rim and tire bead hydraulically. The bead breaker damp may be angled slightly to compensate for the added length of the teeth and claw.

A challenge is that the extended flange on the wheel assembly may not allow a bead breaker to align properly against the rim and tire bead. A variable riser device as described herein may be used to hold the rim so as to allow the beak breaker to be aligned.

Also, the process of bead breaking may be repeated on different locations of the rim face for complete rim bead and fire bead separation. The variable riser device may thus be used to hold the separation of a location while the bead breaker is used in a different location.

An exemplary variable riser device includes an elongate member having a plurality of steps along a length of the elongate member. Each step is located on a different side of the elongate member. Each step includes a top flat surface that juts perpendicularly inward toward the linear straight axis of the elongate member. Also, each step is spaced linearly apart from each other along the length of the elongate member.

Another exemplary variable riser device includes an elongate member with a square- or rectangular-like cross section. The elongate member includes a base step on a bottom section of the elongate member. The base step spans an entire first length of the elongate member. The base step includes chamfered or rounded corner edges. A second step is located on an adjacent side of the elongate member relative to the base step. The second step includes a height along the elongate member that is above the base step. The second step extends a second length of the elongate member minus a width of the bottom step. A third step is located on an adjacent side of the elongate member relative to the second step. The third step is on an opposite side of the elongate member relative to the base step and extends the first length of the elongate member minus a width of the second step. A top step extends above the third step. The top step includes the first length of the third step and a width that is a remainder of the widths of the elongate member minus the second base step and the third step.

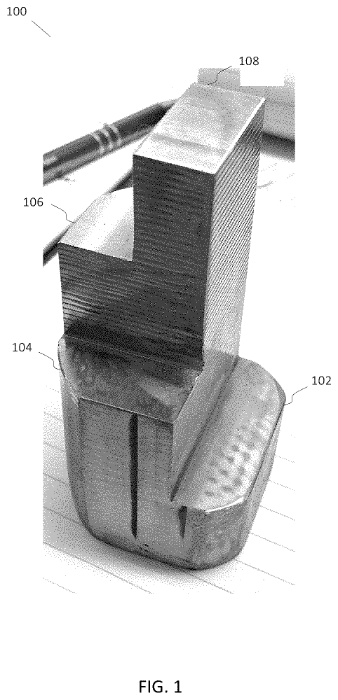

Turning to FIG. 1, a perspective view of a variable riser device 100 is shown according to principles described herein. The variable riser device 100 includes an elongate member. The elongate member includes indentions or steps around a central extension of the elongate member, each step having a perpendicular surface relative to the central axis of the elongate member. The steps increase orderly in height as they wind around the elongate member in a clockwise or counterclockwise manner. In other words, each adjacent side has a step that is higher relative to the neighboring step. Each step has a height that is relatively equal or substantially equally heights to a neighboring step. The winding of steps turn or wind full circle relative to the elongate member such that the highest step is adjacent to the lowest steps.

Other examples include that the steps differ in height as they wind around the elongate member, such as by opposing sides or other manner.

As shown, the base step 102 extends an entire first length of the elongate member while the second step 104 extends a second length of the elongate member less the width of the base step 102. The third step 106 extends the first length of the elongate member less the width of the second step 104. The top step 108 includes a width that is less than the second step 104 and a width that is less than the second base step 102 and the third step 106.

The first and second lengths and height of the elongate member allows for an ergonomic hold of the variable riser device 100. Each step height provides a height for a hand hold and grip by a standard user. In an example, each height is the same or different from each other. In another example, at least one height is the same as another height.

The elongate member has a square or rectangular cross section. Note, however, that corner edges of the elongate member are rounded or chamfered. The top step 108 does not have corner edges that are rounded or chamfered and are not outer corners. In an example, some, or all corner edges of the elongate member, are rounded or chamfered or sharp.

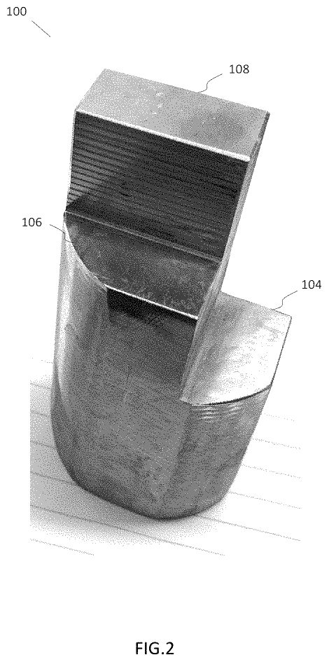

In FIG. 2, another perspective view is shown of the variable riser device 100. The second step 104 and third step 106 are shown at perpendicular sides of the elongate member. Each corner of the second 104 and third step 106 is aligned with a respective corner of the elongate member and is rounded. The rounded corners allow the elongate member to pivot underneath pressure of a rim. The flat edge of the first 102 (not shown in FIG. 2), second step 104, and third step 106 provide a substantially parallel edge with the edge of the rim. The width of the steps 102, 104, 106, 108 are dimensioned to provide adequate support of an edge of a rim. The heights of each step 102, 104, 106, 108 provide incremental adjustments for rim separation by a simple lift and twist of the variable riser device 100.

Note that more or less steps may be incorporated and that more than four sides may be present on the elongate member. Any polygon cross-sectional shape (hexagon, pentagon, triangle, etc.) may be used.

In an example, the surface of each step is parallel and horizontal relative to each other and a ground surface. Examples include that at least one step be parallel and horizontal relative to each other and the ground surface. Other examples include surfaces that are not parallel or horizontal to each other and a ground surface.

Sides of the steps may be flat and parallel relatively to each other along the vertical height of the elongate member. Examples include that at least two steps be flat and parallel to each other. Examples further include that the steps are not flat and parallel.

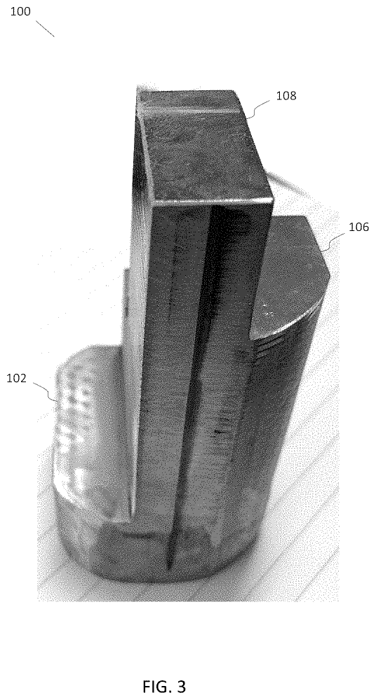

Turning to FIG. 3, another perspective view is shown. This view illustrates a straight, flat surface on one side of the elongate member. The surface is flat from the bottom of the elongate member to the top edge of top step 108. Adjacent to the top edge 108 on first side is the base step 102 and on the second side is the third step 106. Edges of the top step 108 are sharp, but may be rounded or chamfered in other examples.

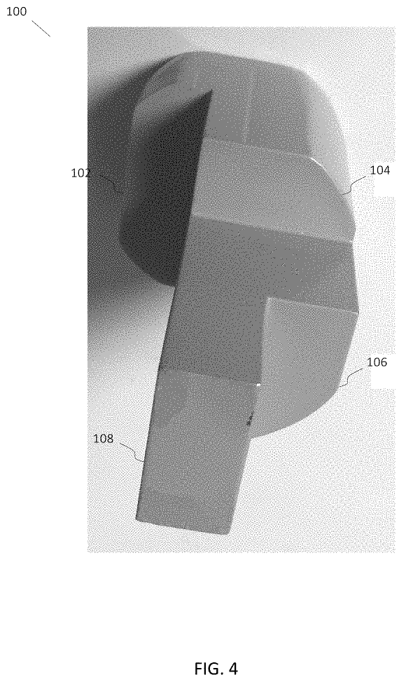

FIG. 4 illustrates a perspective view of the variable riser device 100 with each of the top step 108, base step 102, second step 104, and third step 106 being visible. In an example, each width is the same or substantially the same for manual control and support of the rim. In other examples, at least one or more dimensions, such as the width, vary from each other.

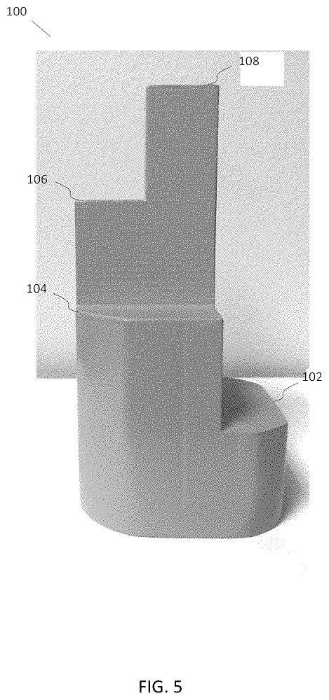

FIG. 5 illustrates a perspective view of the variable riser device 100 with each of the top step 108, base step 102, second step 104, and third step 106 being visible. This view illustrates how a width of the third step 106 is equal to half, or substantially half, of the length of the second step 104. The width length of the base step 102, and the length of the top step 108, is also equal to half, or substantially half, of the length of the second step 104.

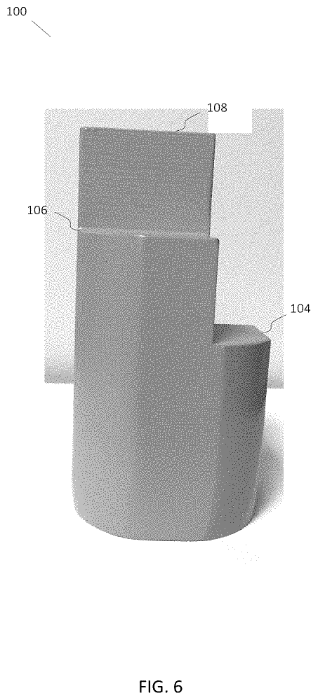

FIG. 6 illustrates a perspective view of the variable riser device 100 with the top step 108, third step 106, and second step 104 being visible. This view illustrates that the length of the top step 108 is the same or substantially the same as the length of the third step 106. The width length of second step 104 is half, or substantially half the length of the third step 106 and top step 108.

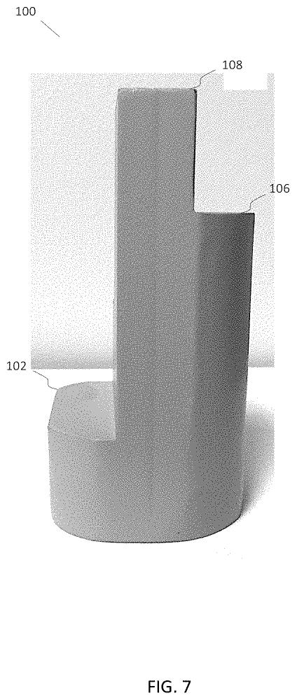

FIG. 7 is a back view of the variable riser device 100 and illustrates how the heights increase the same relative to each other. Particularly, each step grows in height the same amount as the height of the base step 102. Thus, the height of the top step 108 is higher than the height of the third step 106 by the height of the base step.

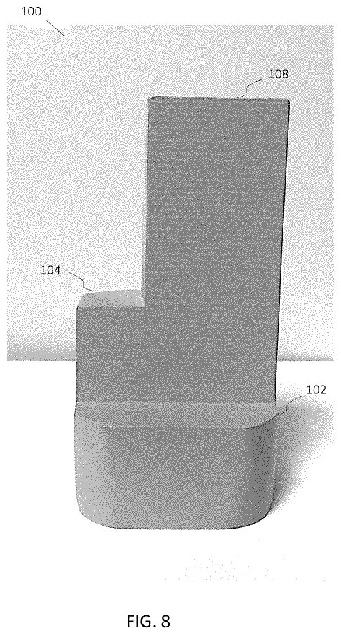

FIG. 8 is a perspective view that shows the base step 102, second step 104 and top step 108. The corner edges of the base step 102 span the entire length of the elongate member and are rounded. Note that the side surface of the base step 102, second step 104, and top step 108 are smooth. In another example, at least one surface includes a texture, such as a coarseness or pebbling or other surface feature.

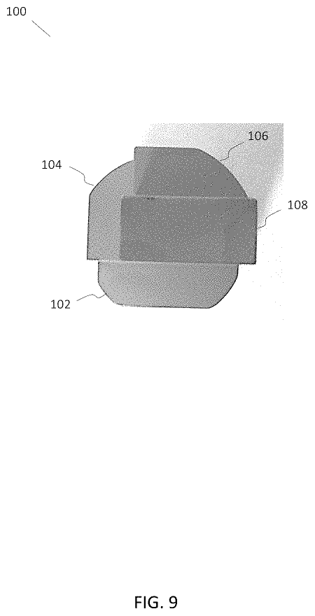

FIG. 9 illustrates a top view of the variable riser device 100. From this view, all of the corner edges of respective steps that are visible. Each corner edge that defines outer corners of the elongate member are rounded so that none of the outer corner edges of the elongate member are sharp. The widths are substantially the same for each step. At least one length is the same in an example. In other examples, the lengths all vary from each other.

The dimensions and material of the elongate member are such that a high pressure, or a pressure for holding a space between components of a multi-piece wheel assembly, can be withstood. The material may include, for example, metal (e.g. steel, aluminum, iron, metal alloy, etc.), plastic, a combination thereof, and other materials known in the art.

In further examples, more than one step is located on a side of the elongate member. The steps may be adjacent to each other on a side or separated from each other by a space.

Multi-piece wheel assemblies are designed to cover rough terrain, with applications for such places as quarries, construction sites, industrial complexes, ports, terminals, surface mining, underground mining, etc.

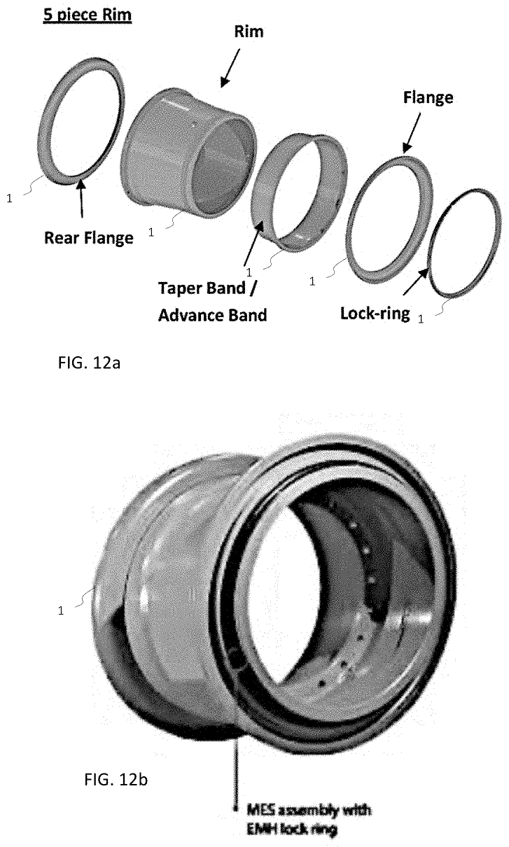

A multi-piece rim may be used on an industrial tire which includes a variety of elements that may be removed separately or in groups from a tire. As shown in FIG. 12a, the elements of a five-piece rim include a rear flange, rim, band ring, front flange, and lock ring. An assembled multipiece rim is shown in FIG. 12b. The band ring is slidably inserted over the rim. A rear flange is slidably inserted over a rear end of the rim. A top flange is slidably inserted over top of the rim. Lock ring is nested within the top flange or otherwise included with the assembly. As part of dissembling the multipiece rim, the variable riser device 100 may be used to remove at least one component of the multipiece rim. For example, the variable riser device 100 may be used for removing the top flange must from a band ring.

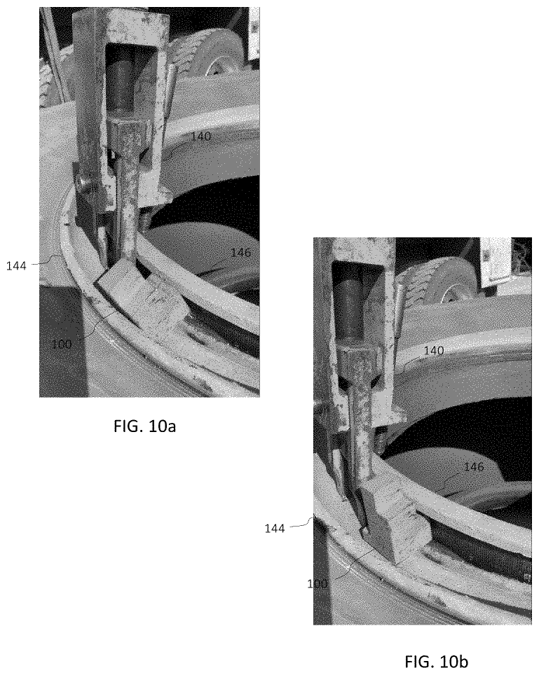

A bead breaker is a tool that is used for breaking the seal and separating the tire from the rim. The bead breaker may be semi-automated or otherwise apply hydraulic pressure to lift components. The bead breaker has a lever or foot that is inserted between the rim and the tire. The foot gets actuated to loosen the top flange from the band ring. The foot takes a bite by lifting the band ring to create a space of separation. A piece of steel or other structure may be inserted to hold the space while the bead breaker is moved to another space around the circumference of the top flange connection. Turning to FIGS. 10a and 10b, a variable riser device 100 is placed within the space between the top flange and the band ring instead of a piece of steel.

In FIG. 10a, the variable riser device 100 is tilted with a second step 104 leaning against the edge of a top flange 146. Once the displacement of the top flange 146 provides enough clearance for the height of the second step 104, the variable riser device 100 is lowered so that the second step 104 may be inserted within the space provided between the top flange 146 and the band ring 144, as shown in FIG. 10b.

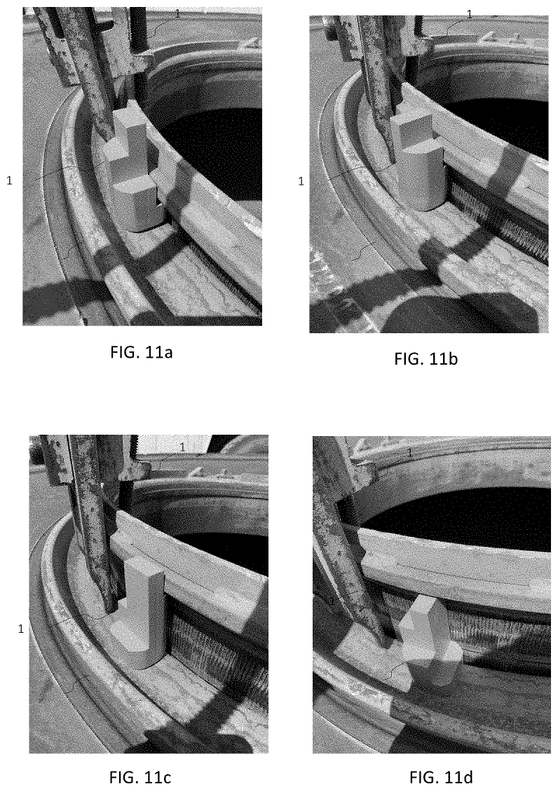

In FIGS. 11a, 11 b, 11c, and 11d, views are shown of the variable riser device 100 being inserted in the space between the top flange and the band ring. FIG. 11a illustrates the base step 102 being inserted in the space. FIG. 11b illustrates the second step 104 being inserted in the space. FIG. 11c illustrates the third step 106 being inserted in the space. And, FIG. 11d illustrates the top of the variable riser device 100 inserted in the space. The different steps can be selected as a space becomes available or made manifest by rotating the variable riser device 100 into a next position. In an example, the variable riser device 100 is rotated axially from the base step 102 to the second step 104 to the third step 106. Examples include that the top step 108 be used. Further examples includes that at least one or more steps be bypassed. So for example, the second step 104 may be omitted and the rotation go from the base step 102 directly to the third step 106.

Note that the variable riser device 100 can be used to separate other components of a multi-piece rim. Also note that the variable riser device 100 may be used with a two-piece, three-piece and four-piece rim.

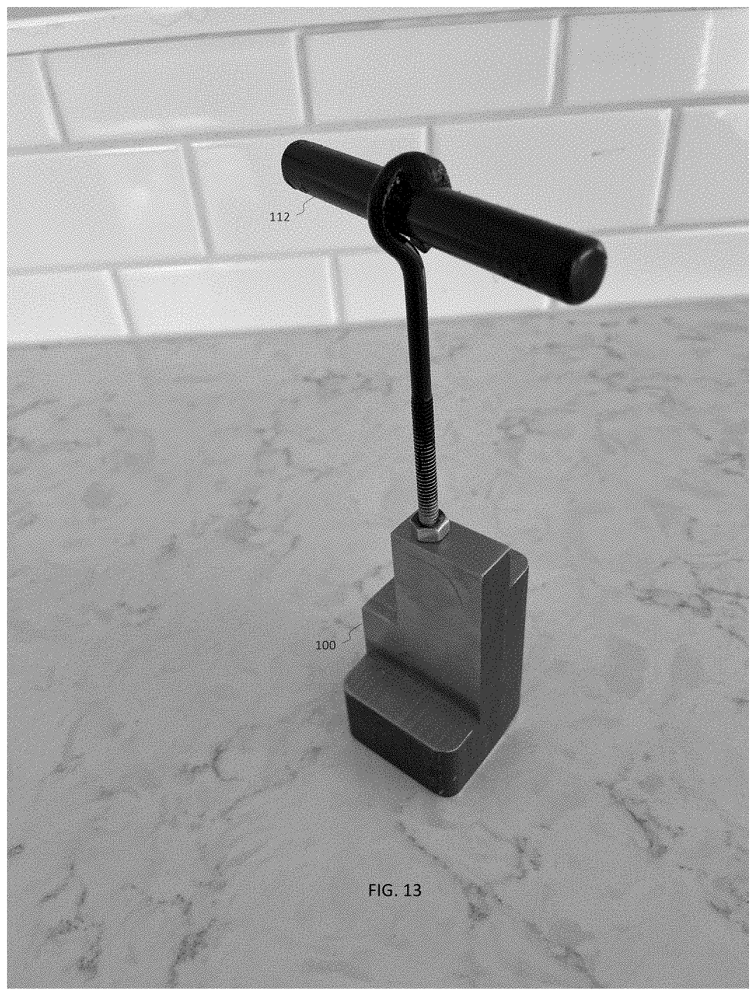

In FIG. 13, the variable riser device 100 is shown with a handle 112. The handle 112 includes an elongate member that extends vertically upward relative to the top surfaces or bottom surface of the elongate member of the variable riser device 100. The handle 112 may also extend obliquely in some examples. The handle 112 may be simply the extended member or may include a handhold such as the handhold on the handle 112 which includes a horizontal rodlike member that is attached at its central location to the end of the elongate member of the handle 112. The handle 112 is useful for lifting and maneuvering the variable riser device 100 in all its functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be apparent to one skilled in the art that examples consistent with the present disclosure may be practiced without these specific details. Reference in the specification to “an example” or similar language means that a particular feature, structure, or characteristic described in connection with the implementation or example is included in at least that one implementation, but not necessarily in other implementations. The various instances of the phrase “in one implementation” or similar phrases in various places in the specification are not necessarily all referring to the same implementation.

What is claimed is:

1. A variable riser device comprising:
an elongate member;
a plurality of steps along a length of the elongate member, each step located on a different side of the elongate member, each step having a top flat surface that juts perpendicularly inward toward the linear straight axis of the elongate member, each step spaced linearly apart from each other along the length of the elongate member.

2. The variable riser device in claim 1, wherein the elongate member is shaped for manual handling by a user.

3. The variable riser device in claim 1, wherein the relative height between each step is equal.

4. The variable riser device in claim 1, wherein at least two steps are on adjacent sides of the elongate member.

5. The variable riser device in claim 1, wherein the sides of each step are flat.

6. The variable riser device in claim 1, wherein at least one corner edge is rounded or chamfered.

7. The variable riser device in claim 1, wherein at least one bottom edge of the elongate member is rounded or chamfered.

8. The variable riser device in claim 1, wherein the elongate member includes a material with strength to withstand at least 1000 psi.

9. The variable riser device in claim 1, wherein the top flat surface of each step extends a distance that is greater than half way to a central axis of the elongate member.

10. The variable riser device in claim 1, wherein the top flat surface of each step extends a distance that is less than half way to a central axis of the elongate member.

11. The variable riser device in claim 1, wherein a bottom step includes that both corner edges are rounded or chamfered.

12. The variable riser device in claim 1, wherein the bottom step extends a width of the elongate member, a second step extends a width of the elongate member minus a width of the bottom step, and a third step 106 extends a width of the elongate member minus a width of the second step.

13. The variable riser device in claim 1, wherein a top of the elongate member has a flat top surface that extends through a central axis of the elongate member.

14. The variable riser device in claim 1, wherein the elongate member has a cross section with equal lengths.

15. The variable riser device in claim 1, wherein the elongate member has lengthwise side corners that are chamfered or curved.

16. The variable riser device in claim 1, wherein the plurality of steps increase in height with each adjacent side of the elongate member in a clockwise or counter-counterclockwise manner.

17. A variable riser device comprising:
an elongate member;
a plurality of steps along a length of the elongate member, each step located on a different side of the elongate member, each step having a top flat surface that juts perpendicularly inward toward the linear straight axis of the elongate member, each step spaced linearly apart from each other along the length of the elongate member.

18. A variable riser device comprising:
an elongate member with a square like cross section;
a base step on a bottom section of the elongate member, the base step spanning an entire width of the elongate member, the base step having chamfered or rounded corner edges;
a second step on an adjacent side of the elongate member relative to the base step, the second step having a height along the elongate member that is above the base step, the second step extending a width of the elongate member minus a width of the bottom step;
a third step on an adjacent side of the elongate member relative to the second step, the third step being on an opposite of the elongate member relative to the base step, the third step extending a width of the elongate member minus a width of the second step; and
a top step that extends above the third step, the top step having a width of the third step and a width that is a remainder of the widths of the elongate member minus the second base step and the third step.

19. The variable riser device 100 in claim 18, wherein the base step, the second step, and the third step each have flat surfaces that lay perpendicular with a central axis of the elongate member.

20. The variable riser device 100 in claim 18, wherein a top surface and a bottom surface of the elongate member is flat.
